(19) United States
(12) Patent Application Publication
(10) Pub. No.: US 2007/0200929 A1
(43) Pub. Date: Aug. 30, 2007

(54) System and method for tracking events associated with an object

(76) Inventor: Ronald L. Conaway JR., Coral Springs, FL (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/702,300

(22) Filed: Feb. 5, 2007

Related U.S. Application Data
(60) Provisional application No. 60/765,294, filed on Feb. 3, 2006.

(51) Int. Cl. H04N 7/18; H04N 5/225

(52) U.S. Cl. 348/157; 348/169

(57) ABSTRACT

The present invention relates to a system and a method for tracking an object capable of being used at a sporting event. The object has a unique identifier that is capable of being read by a scanning device. The system provides recording devices and event tracking devices for recording and detailing events occurring with the object, players possessing the object, time and location of the object and other information associated with the object and the sporting event. A database is provided for storing the information and the unique identifier. The database is searchable to locate the information.

### CROSS-REFERENCE TO RELATED APPLICATION

This application claims priority from U.S. Provisional Patent Application No. 60/765,294, filed on Feb. 3, 2006, and titled SYSTEM FOR AUTHENTICATING THE ORIGIN AND EVENTS ASSOCIATED WITH A SPECIFIED PIECE OF EQUIPMENT, which is hereby incorporated in its entirety by reference.

### FIELD OF INVENTION

The present invention relates generally to a data processing system and more particularly, to a system for monitoring objects associated with an athletic competition or event in order to authenticate the origin and events associated with that particular object.

### BACKGROUND

Sports memorabilia is a multi-million dollar industry. The value of an object in this industry (e.g., a ball or other piece of sporting equipment) is typically directly related to the origin of the object, such as, the particular events associated with or occurring with object. However, in the case of fungible items such as game balls or other non-distinctive items, it is sometimes difficult if not impossible to discern which ball was used on which particular play. Therefore, a system for authenticating the origin of such sporting equipment would be a boon to the memorabilia industry.

Similarly, during sporting events where the equipment used in the event is subsequently surrendered to a non-participant (i.e., a spectator, trainer or other non-participant), the equipment can become extremely valuable depending on events that may occur during the competition. Accordingly, the non-participant and/or assigns of the non-participant may seek to authenticate the origin of the object and/or events associated with the object.

The industry has attempted to provide distinguishing marks on objects that have a high probability for being valuable, for example, baseballs pitched to a player approaching a homerun record. However, use of such distinguishing marks may be counterfeited. Moreover, the industry has not implemented a system where a user, such as a non-participant of a sporting event can authenticate the origin of the object. Further, such markings are limited in use and require unique applications for each object. Therefore, an equipment monitoring and authentication system is needed in the industry.

Given the above, a system that tracks and authenticates sporting equipment is needed. In particular, a system that seamlessly integrates with currently used equipment and that allows an authoritative body, such as a team, league or sanctioning body, to verify the origin and events associated with such equipment is needed. Additionally, a system that is remotely accessible to generate a verified record as to provenance and history of the object is needed.

### SUMMARY OF INVENTION

The present invention addresses the aforementioned needs, in addition to others, by providing a system and method for monitoring and subsequently authenticating equipment. The invention contemplates a system for monitoring objects, such as, sports equipment. Each object may have a unique identifier and/or object code. A device tracks the object and/or the events associated with that object. A database that may incorporate software logs usage of the object and events associated with the object. Numerous devices capture information related to the object. The database and/or the software provides authentication of the events and identification of the origin of the object.

### BRIEF DESCRIPTION OF THE DRAWINGS

FIG. 1 illustrates a system for tracking an object in an embodiment of the present invention.

FIG. 2 illustrates an event time line for an object in an embodiment of the present invention.

FIG. 3 illustrates a system having a plurality of remote systems in an embodiment of the present invention.

FIG. 4 illustrates an identifier for an object in an embodiment of the present invention.

FIG. 5 illustrates an example of sporting event codes in an embodiment of the present invention.

FIG. 6 illustrates event time lines of objects in an embodiment of the present invention.

FIG. 7 illustrates an assembled time line from a plurality of devices in an embodiment of the present invention.

FIGS. 8a-8c illustrate certificates that display information related to an object in embodiments of the present invention.

### DETAILED DESCRIPTION OF THE PREFERRED EMBODIMENTS

The invention contemplates a system for authenticating and/or identifying the origin and events of objects. Each object has unique object information that may be stored in the system. The system may store event information, such as, time information, visual information, statistical and/or actions performed with the object. The system logs specific events defined by the system user in order to create a comprehensive record of all of circumstances associated with that particular object. The system is capable of searching, locating and/or identifying data, such as, visual data, statistical data and informational data based on the object. The system may produce a report to authenticate and/or identify the origin of the object.

The invention may be used in various industries. The following description highlights the features of the invention in reference to sports memorabilia, for example, baseball memorabilia. However, it should be understood that the invention may also be used in any range of other sports where pieces of equipment which are essentially fungible or otherwise difficult to differentiate from one another are used and/or subsequently distributed to spectators or other persons in a manner that makes the true identity and origin of that equipment difficult to determine. By way of example rather than limitation, the inventive system could be implemented in golf, tennis, football (including arena football and other variants), rugby, table tennis, lacrosse, soccer (indoor and outdoor), bowling, basketball, hockey or other athletic competitions in combination with the balls, shoes, gloves, clubs, rackets, bats, sticks, helmets, mouth guards, jerseys, other apparel and/or other equipment used in those competitions.

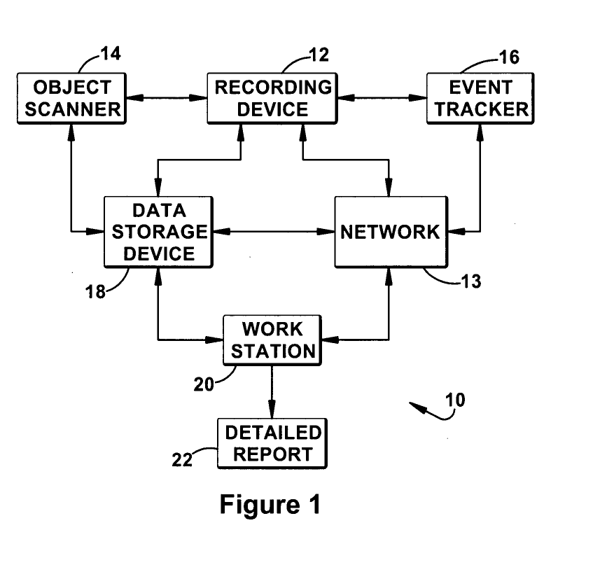

FIG. 1 provides a schematic of the processes and systems of in an embodiment of the present invention. System 10 has a recording device 12, an object scanner 14 and an event tracker 16. The recording device 12, the object scanner 14 and the event tracker 16 may be linked and/or may be in communication via, for example, a network 13. The recording device 12, the object scanner 14 and the event tracker 16 may communicate with, may store information and data on, and may transfer data to a data storage device 18. The object scanner 14 may detect, read and otherwise access information and data associated with the object 19. The storage device 18 may be accessed remotely and/or may be local with respect to the recording devices 12, the object scanners 14 and the event tracker 16. A work station 20 is in communication with the storage device 18. The work station 20 may access, may modify, may arrange and may search information and data stored on the storage device 18. In an embodiment, the work station 20 accesses the storage device 18 to produce a detailed report 22. A user 21 may personalize and/or define parameters of the detailed report 22.

The objects 19 may be any tangible objects that the user 21 may desire and/or may be required to authenticate. The system 10 allows identification of the origin of each of the objects 19 and/or tracking of events occurring with each of the objects 19. Accordingly, the user may desire and/or may be required to track, to locate and/or to determine the origination of one or more of the objects 19. In an embodiment, the objects 19 are sports memorabilia, such as, sports equipment, such as, bats, balls, shin guards, baseballs, basketballs, hockey pucks, hockey sticks, golf balls, golf clubs, gloves, jerseys, caps, hats, bases, armbands, headbands, wristbands, rackets, shoes, pompoms, water bottles, clip boards, score cards, golf clubs, paddles, visors, megaphones and/or the like. The system 10 should not be deemed as limited to sporting events and/or sport memorabilia. The system 10 will operate with any tangible object capable of retaining coded information.

Each of the objects 19 may have an identifier 40 that distinguishes the objects 19, as illustrated in FIG. 4. In an embodiment, each of the objects 19 has a unique identifier 40 that may consist of numbers, letters and/or symbols. The identifier 40 may be an object code 42, such as, a generic object code, a “born on” object code, a player related code and/or a team related code. In one embodiment, the identifier 40 is a barcode. The barcode may be a machine-readable representation of the identifier 40.

The generic code may be a code that has no relevance to the object 19 other than identifying the object 19. The “born on” object code may be derived from the time and/or the location in which the identifier 40 of the object 19 is stored in the storage device 18. In an embodiment, the “born on” object code may be and/or may contain global positioning system (“GPS”) coordinates of, for example, a location in which the identifier 40 is created, produced and/or applied to the object 19.

A player and/or team related code may be an object code that identifies and/or associates players and/or teams with the object 19. The player and/or team codes may be used to associate the object 19 with a specific player, for example, game items that the player will use during games in a season, such as, jerseys, bats, helmets, pads, gloves, protective gear, sticks, shoes and/or the like. As an example, each player may be assigned an object code 42 and place the object code on each piece of equipment that the player will use in an upcoming event. The object code 42 may identify the type of equipment, size of the equipment, manufacturing date and/or the like.

In an embodiment, a roster may be provided and/or may be created from the storage device 18. The roster may list the players that participate in the game along with the player code identifying each player. The roster may have provide information associated with the event or game that uses the object 19, such as, starting pitchers for the game, game conditions, records of each of the teams participating in the game and/or the like.

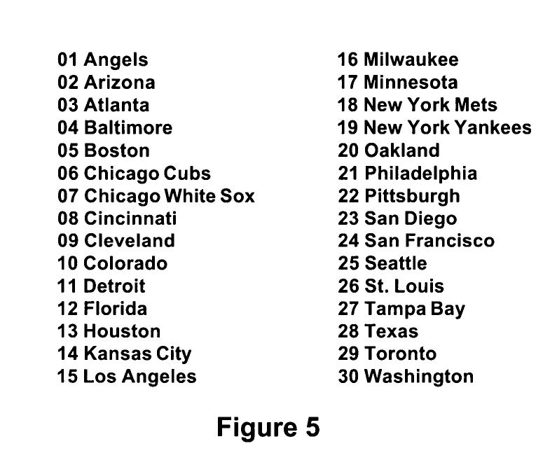

As an illustrative example, the object 19 may be a baseball that will be used in a Major League Baseball (hereinafter “MLB”) game. In order to differentiate one ball from another, each ball may have the identifier 40 that may be the object code 42. In this embodiment, the object code has three sections or portions. Section one of the object code 42 is a location code consisting of a number ranging from I to 30 that corresponds to the number assigned to the stadium in which the object is being used. FIG. 5 illustrates an example for illustrative purposes of codes for baseball stadiums. Section two of the object code 42 is the generic object code that may be a number and/or a barcode that is a machine-readable representation of the generic object code for the ball. In one example, the number will be unique for every ball used during the duration of the MLB season. Section three of the object code has information as to what season the ball was produced for and/or used during, for example, a ball used in the 2006-2007 MLB season may end in the digits 07. An example of the object code 42 for the 125,009^{th} baseball manufactured for use at the Atlanta Braves Stadium for the 2005 MLB season may be 03-125009-05.

The identifier 40 may be embedded in, attached to, printed on, inked on, stamped on, branded on and/or etched into the object 19. The physical means of marking the identifier 40 on these objects can incorporate any known system. For example, small print, infra-red or other types of “invisible” ink and/or marking on the interior or non-visible portion of the object may be preferred. Radio-frequency identification devices (RFIDs) or other similar devices may also be embedded, implanted or secured to the object 19.

The identifier 40 may be recorded, may be stored and/or may be saved on the storage device 18. The object scanner 14 may read, may scan and/or may otherwise access the identifier 40. The object scanner 14 may transmit, may store and/or may save the identifier 40 on the storage device 18. To this end, the storage device 18 may contain a list of the object 19 and the corresponding identifier 40. The scanners 14 may be in proximity with the object 19 or may access the identifier 40 of the object 19 remotely. Examples of specific types of scanners include bar code readers, RFID detectors, character recognition readers, cameras, optical recognition or machine-vision devices and like devices:

The object scanner 14 may record, may track and/or may transfer time information to the storage device 18. The time information may be recorded on the storage device 18 to determine the location of the object 19 at a specific time. In an embodiment, the time information is a standard of time, such as an atomic time. The time information may determine an atomic life of the object 19.

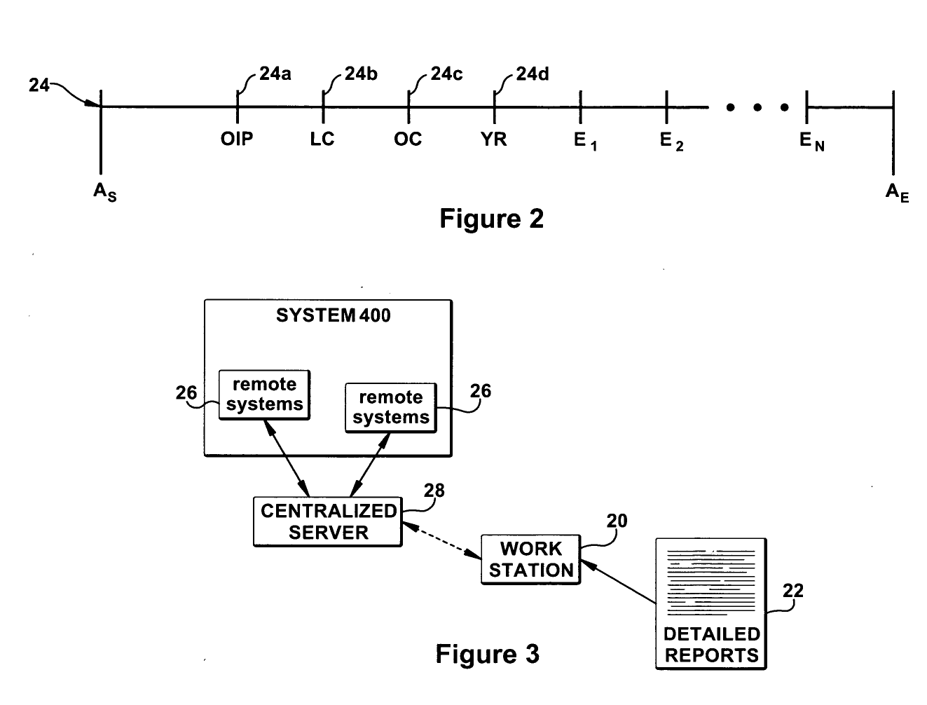

Atomic life is the term that may be used to describe the time that the object 19 is, for example, on the field of play. When the object 19 is on the field, the object 19 is given “life” or in other terms the object 19 is being recorded and tracked by the recording device 12, the object scanner 14 and/or the event tracker 16. The atomic life of the object 19 consists of an atomic start time, and as an atomic end time, Aₛ as illustrated in FIG. 2. An atomic start time may be the time that the object 19 is scanned by the object scanner 14. An atomic end time and the termination of the atomic life occur when the object 19 is replaced by a new object. In an embodiment, the object 19 may have multiple atomic lives. A baseball is an example of the object 19 that may have one atomic life; that is, the baseball is introduced onto the field and when the baseball is hit or thrown out of the field, the baseball is not typically returned. A football, however, is an example of the object 19 that may have multiple atomic lives. The football can be introduced into play, removed from play to be cleaned and then returned to play.

The introduction of a new object 19 may terminate the atomic life of the previous object 19. In the event the object 19 is scanned multiple times in concession, the object 19 may not activate a new atomic life of the object 19. In an embodiment, the atomic end time will only be recorded, tracked and/or transferred from the object scanner 14 to the storage device 18 if the object scanner 14 scans a different or new object 19. For example, the object 19 may be a baseball that was foul tipped and returned to the umpire who rescans the object 19. In such a case, rescanning the object by the umpire will not start a new life of the object 19.

The object scanner 14 is used to record the time that the object 19 is on, for example, the field of play and the time in which a new object 19 is introduced into play to replace the object 19. In an embodiment, there may be two types of object scanners 14—off-field scanners and on-field scanners. Off-field scanners may record and/or may access the identifier 40 of the object 19 off of the field of play. The off-field scanners may be used to record the objects 19 that may be used during the game and/or event. For example, the off-field scanners may scan and may record the identifiers 40 from the objects 19 prior to or after the game or event. The off-field scanner may be an object scanner 14 that is located remotely with respect to the location of the event or the game. The on-field scanner, however, may record, may track and/or may access information relating to the object 19 during the game, at the game or event and/or the like.

The object scanner 14 may record the identifier 40 for each of the objects 19, such as, bats, helmets, protective gear, gloves, sticks and the like prior to use at an event or game. In one embodiment, the object scanner 14 records the start of the game or the event involving the object 19. The start of the game or event may be input into the storage device 18 from the work station 20 and/or from a remote server or the network 13. Using baseball as an example, an umpire may have the object scanner 14 mounted to and/or incorporated into his/her protective gear and may scan each baseball (the object 19) prior to entering the baseball into play. The object scanner 14 may record the GPS location, the time, the atomic time and the identifier 40. The object scanner 14 may transmit and/or may communicate this information to the storage device 18. In another example, footballs may require scanning or accessing of the identifier 40 prior to each play. Footballs are frequently removed or exchanged for various reasons during a football game. Therefore, the football may be used for a few plays, thrown to the sideline and wiped off for future use. In this example, the football will be scanned each play so that the storage device 18 will have a record of each play involving the football.

In the event the object 19 is used in a subsequent game or event, the identifier 40 of the object 19 may be linked to each of the games by, for example, game identification numbers. The game identification number may be a number to identify and index each game or event occurring with the object 19. The game identification number may be a portion of the object code 42. In an embodiment, the game identification number is a combination of two numbers that record and/or identify the start and end of the game or event. For example, the game identification number and time may be in the format of (x,y,z,t) or x=latitude , y=longitude , z=altitude and t=time. The x, y and z components may be incorporated and/or identified from GPS based on location of the object 19 and/or location of the game or event. The game identification number may be associated with the identifier 40 of each of the object 19 that may be used in the game or event.

In an embodiment, the object 19 may be associated with a game identification starting code and a game identification termination code. To this end, the game identification codes may be used to search and/or to identify each of the objects 19 that were used in a specific game or event. In a further embodiment, the game identification numbers may be fluid or dependent on the event or game in the sense that the game identification start code may include pre-game warm-ups, and the game termination code may include post-game announcements, analysis, press conferences and/or the like.

The recording devices 12 may input, may record and may associate information with the object 19 and/or the time line 24. In an embodiment, the recording devices 12 monitor and maintain a record of the events within a specified time frame, as illustrated in FIG. 2. The recording devices 12 may be in communication with the storage device 18 to record, to save and/or to input information to the storage device 18. The recording devices 12 may track, may record or may otherwise obtain information, such as, visual information, statistical data, time related information, location related information and the like.

FIG. 2 illustrates an embodiment of an event time line 24. Lines 24a-24d are associated with separate encoded objects 19. As represents the start time of the particular event associated with the encoded object 19 that is logged for entry into the competition on the same time-basis by the object scanner 12. OIP (object in play), LC (location code), OC (object code), YR (year) and the string of occurrences or plays represented by E₁ through E_{N} are specific events identified and monitored by the system 10, and it should be understood that other combinations of information or events can be incorporated without departing from the principles of this invention.

The recording devices 12 may have a GPS incorporated or accessible such that the recording device 12 may embed GPS information into the information recorded, captured and/or saved by the recording devices 12. The recording devices 12 contemplated include but are by no means limited to video cameras, digital video recorders, digital cameras, microphones, radar guns, security cameras, specialized scorekeeping devices including but not limited to the type disclosed in U.S. Pat. No. 6,041,266, software or other controllers used in scoreboards or scoring systems. The recording devices 12 may record the GPS location and the time and digitally embed the GPS coordinates and the time onto recordings of the objects 19 for future referencing.

Digital cameras incorporating GPS technology, for example, can digitally embed each frame of recording with the x,y,z,t coordinates of the object 19. The x,y,t coordinates and the identifier 40 may be assigned to the events for future referencing. Each individual camera may have a unique serial number that may be incorporated into the identifier 40. The serial number may be embedded into the identifier 40 for identification of the origin of the footage/picture.

Photographs from the recording devices 12, for example, may be taken in a stadium from different vantage points of the same event. The photographs may be indexed with the corresponding timeline 24 as illustrated in FIG. 2. The information may include the GPS and time at which the photograph was taken and the identifier 40, such as the serial number of the camera. The importance of the serial number is in the event that two cameras, in close proximity of one another, take a picture at the same given time the photographs will be distinguishable between one another when uploaded onto a common server or storage device 18. In such an embodiment, the identifier 40 of the two photographs will be distinguishable on the storage device 18 by a suffix, prefix and/or other portion of the identifier 40 incorporating the camera serial number.

The following is an example of a use of the system 10. Cameras that embed GPS and time on recorded images or video, for example, may be used in a baseball stadium. A ball with the identifier 40 as discussed above may enter play and may be scanned by the umpire. The GPS device may identify the atomic start time and the location code associated with the identifier 40 of the ball. During the time the ball is on the playing field, individuals in the stands are photographing the events on the field and the events in the stadium—whether the events are pictures of the playing field or pictures of audience members. In addition, nearly all MLB games are televised and, as a result, are recorded by a number of video cameras. This video information may be embedded with the GPS information, the identifier 40 and/or the serial number of the camera and transmitted to the storage device 18. To this end, the storage device 18 may contain information from multiple sources that is associated with the object 19.

The information, data and/or video from the recording devices 12 may be combined, embedded and/or synchronized with the identifiers 40. In an embodiment, the identifiers 40 of the object 19, the player, the team and/or the like may be indexed using the GPS and atomic time. In a particular embodiment, the information may be indexed into a format, such as, (x,y,z,t)/the identifier 40.

The event trackers 16 may embed and/or may synchronize events related to the object 19 with the information from the object scanner 14, the timeline and the information from the recording devices 12, such as video footage. In order to do so, the event brackets 16 may be required to input missing and partial and/or data received from the recording devices 12 and/or object scanner 14. If the recording device 12 contains GPS capabilities, the recording device 12 will record the exact location and time the ball is on the field or X,Y,Z,T. If the recording device 12 does not contain a GPS system, the object 19 will be assigned a location code depending upon the stadium in which the object 19 is located and will transfer the stadium code to the timeline 24. The recording device 12 may record the time in which the ball is on the field. If the object scanner 14 does not have a GPS system the X,Y,Z could be programmed into the device to be a constant and the T or time the object is on the field will be the variable. This number could also be used to warehouse balls being that the number is linked to the identifier 40 on the ball, as illustrated in FIG. 4.

The event trackers 16 may record, may track and/or may identify events and/or actions occurring with the object 19. The event trackers 16 may identify actions, occurrences and/or plays occurring with the object 19. The events of each game or competition in which the object 19 is used may be recorded and may be maintained on a database, such as the storage device 18. Each event may be recorded on a time-basis. In the same manner, the introduction of each of the objects 19 onto the field of play is preferably made on a time-basis, so as to allow for a distinct identification of the events associated with the object 19.

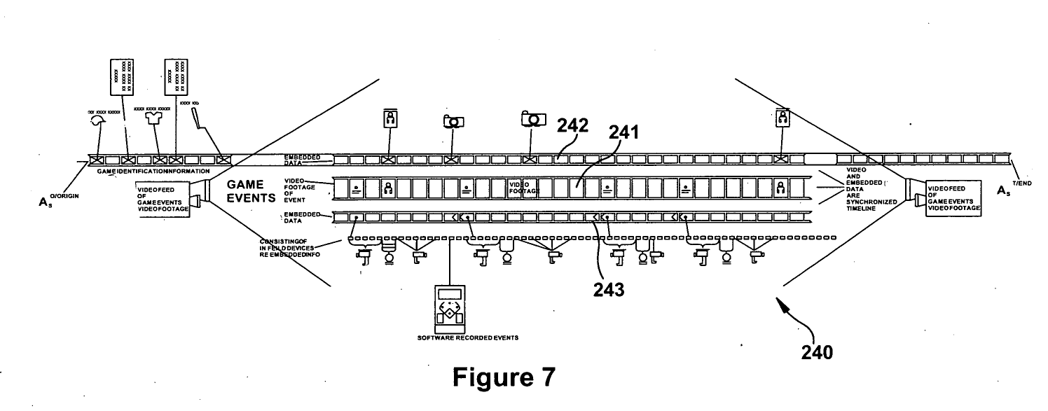

Again, with reference to the MLB example, the official score-keeper (or other person observing the game) would record the events of each at-bat or of each pitch and the precise time at which it occurred. Separately, the umpire, player or manager would note the object 19 being used on a precision time basis (preferably by way of a barcode scanner or RFID device, so as to minimize or eliminate any delays to the pace of the game). The information, data and/or video from the recording devices 12, the object scanners 14 and the storage device 18 may be synchronized and/or combined into the time line 240, as illustrated in FIG. 7. The timeline 240 illustrates the combination of the timeline 24, corresponding to information from the recording devices 12 as well as information from the object scanner 14.

The result of synchronizing information from the events related to the object 19 with object scanner 14 and the recording devices 12 is illustrated in FIG. 7. In this embodiment, a timeline 240 is produced that contains video 241 footage of the game along with data from the object scanner 24 and the recording devices 16. Data from recording devices 12, such as, a camera is embedded as illustrated in timeline 242. Data from recording devices 12, such as, radar guns may be embedded as time line 243. Accordingly, combining the timelines 242, 243 wit the video footage 241 results in the timeline 240.

The event time line 24 may be modified, may be created and/or may be arranged by the event trackers 16 as illustrated in FIG. 7.

In an embodiment, the event time line 240 may be automatically generated by the recording devices 12. The event time line 240 may be supplemented or may be independently generated by event trackers 16, such as, a third party observer, for example an official scorekeeper. The event trackers 16 may automatically determine the events associated with the object 19 by, for example, being linked to and/or may be in communication with a system for recording the events. For example, numerous websites and/or servers provide event information in real-time. Such a website or server may be synchronized with the information from the object scanner 12, the recording devices 12 and/or the storage device 18.

In an embodiment, the event tracker 16 may be software that may be operated independently or by a user. In such an embodiment, the event time line 24 may require synchronizing a first event, such as, the first pitch in a baseball game with the first event of the event time line 24. To this end, the event tracker 16 may input information and/or data relating to the events and/or actions performed on the object 19.

The object scanners 12 and the recording devices 12 may be linked and/or in communication with the event tracker 16 such that information will be automatically recorded. For example, the recording device 12 may be a radar gun that can determine the speed of the pitch, the type of pitch and whether the pitch is a strike or ball. At a minimum, the radar gun may communicate with the event tracker 16 that a pitch has been thrown.

Since all of the devices of the system 10 may be synchronized, the events occurring during the atomic life of the object 19 may be recorded the devices, compiled into a central server and arranged into the event time line 240. Using the baseball example, the event trackers 16 may record and/or may identify, the players who pitched, caught and/or fielded the baseball and results of each at-bat associated with that baseball. The event trackers 16 may use known scoring methods of baseball, such as, identifying the play by representing each position as a number. In an embodiment, this information may be provided to the system 10 by, for example, an external scoring system and/or remote network. The precise software and networking of the devices in the system 10 can be achieved and modified by one of ordinary skill in the art.

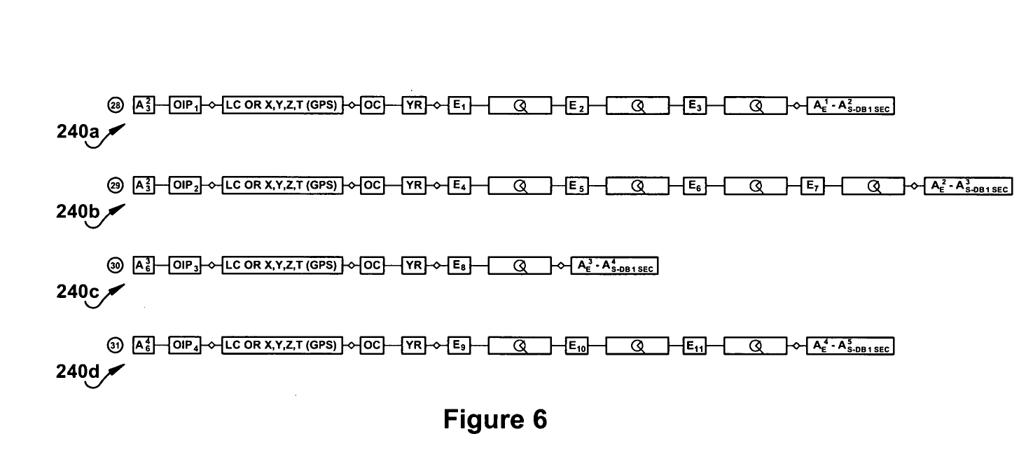

The event tracker 16 tracks the events of the object 19, synchronizes these events with the other information provided to the system 10 and/or the storage device 18 to create the event time line 240. FIG. 6 illustrates four time lines 240a-240d of four objects 19 for illustrative purposes. Each of the event time lines 240a-240d begin at the atomic start time of the objects 19. The atomic start time begins the atomic life of the objects 19 and may automatically trigger and/or identify that the object 19 is in play as indicated by “OIP”. The OIP accounts for each object entering the field of play and/or scanned by the object scanner 14. The identifier 40 for each of these objects 19 is identified with the object code (“OC”) and a corresponding year (“YR”). The event tracker 16 records and/or tracks each event as illustrated by “Eₓ”. Following each event Eₓ is a chain of events that are recorded by the event tracker 16. In this embodiment, software and/or a data processing program may record the events of each of the objects 19. In baseball, for example, each of the events Eₓ may be a pitch and/or a result of the pitch. In the case of multi-event sports in which the ball is thrown into play and can switch hands of teams (basketball, soccer, rugby), the event may be the starting of the clock and the stopping of the clock during which the ball is in play.

In such an embodiment, E₁ of the time line 240a may be a pitch that is thrown for a strike. Accordingly, the E₁ of the time line 240a may describe the location of the pitch, the player that threw the pitch, the speed of the pitch, the type of pitch (e.g. fastball, breaking ball or the like), the location of the pitch, the player that received the pitch and the like. Each player may be identified using the player code.

In an embodiment, the event time line 240a may be the first ball in play during a baseball game. The ball may be scanned by the umpire. When the ball is scanned by the object scanner 14, the object scanner 14 records the identifier 40, such as the barcode, of the ball and takes the GPS and time readings of the ball. This information is then transmitted, recorded and/or otherwise linked to the barcode. In addition, the object scanner 14 may record or identify the number of balls introduced onto the playing field. In such an embodiment, the object scanner 14 maintains a tally on how many new balls may have been introduced into play. This number may be used to validate the number of balls that were thrown into play and to check that each of the barcodes was properly scanned and/or recorded by the object scanner 14.

After the ball has been scanned, the ball enters play and information that is placed on the timeline 240a may be entered via a computer, for example, having software that will allow operators to drag and drop the object codes 42 of players onto the timeline 240a that have possessed the ball at the exact point and time that the player contacted and/or took possession of the ball. The software may allow the operators to drag and drop scoring information of the play, such as, the scoring of the play represented by known play recordings methods for recording plays into a play book. For example, the ball represented by the event timeline 240a has gone through three separate events before the ball was removed and/or hit out of play. It was pitched three separate times and the third time the result was the ball being taken out of play or hit out of play. Then, a new ball was brought into play by the umpire and the atomic end time was recorded for that ball, as indicated by A_{S}².

The E₃ of the time line 240a results in the object 19 leaving the field of play, for example, the object 19 may be hit for a home run. The E₃ of the time line 240a may describe and/or identify the player hitting the homerun, the distance of the homerun, the location of the homerun with respect to the field of play and/or the like. The event time lines 240a-240d terminate upon, for example, the object scanner 14 accessing and/or recording the identifier 40 and/or the object code of the new object 19. In an embodiment, the atomic termination time of each of the objects 19 may be modified and/or changed to account for delay in scanning the new object 19. In such an embodiment, the atomic termination time may be reduced by a predetermined amount of time, such as, 0.001 seconds.

The event time lines 24, 240a-240d may be synchronized, matched and/or otherwise combined with the video footage, the pictures and/or the other data and/or information recorded from the components of the system 10. FIG. 7 illustrates the combination of the video footage of the event along with the embedded data transmitted form the various components of the system 10, such as, the object scanners 14, the recording devices 12 and the event trackers 16. This information may be used to produce a historical record of events and the objects 19 involved.

To this end, the event time line 240 may allow a fan, a collector or other user of the system 10 to identify the events associated with the ball and each player that contacted the ball. The event time line 240 and information and data used to create the time line 240 is stored on the storage device 18. Therefore, the system 10 produces a historical record of events and the objects 19 involved in the events and indexes this information for future reference. The events, the objects 19 and the corresponding information may be searched and/or identified. Then cross-referencing and/or searching of the storage device 18 allows the subsequent identification of the events associated with the object 19, as well as an authentication of the object 19 by, for example, the presence of the unique source identifying encoded information. To this end, searching any given parameter can identify video footage, for example, of the event relevant to the object 19.

For example, the storage device 18 may be a database that is searchable based on the event information, the identifier 40, the location, the time or other information associated with the object 19. In an embodiment, a user may enter a GPS location and a time in which an object may have been used. The storage device 18 may identify and/or locate each of the objects 19 used in sporting events at the GPS location and the time. In one embodiment, the GPS location and the time information identified by the user may be extended or expanded to identify the objects or the information associated with the objects 19. To this end, the time and the GPS location information entered may have a tolerance to increase the ability to identify the objects 19 and the information associated with the objects 19.

As an example, a user may identify the object 19 and a time range of 9:00 pm to 10:00 pm. The user may desire to identify the information and data related to the object 19 that occurred between 9:00 pm to 10:00 pm. The system 10 may search or actually identify the information and/or data related to the object that occurred between 9:15 pm to 10:15 pm. The GPS location code may also be expanded a predetermined amount in searching the data and information associated with the object 19.

As an example, a user may know that a specific object 19 was used at a given location and a given time. The user may desire to identify video footage that may have captured the object 19 occurring at that time and that location. Limiting a search to the GPS location may fail to identify video footage taken a distance from the object 19. As an example, video footage may be taken from a blimp or airplane. The user may input a GPS location or range within the stadium or field of the sporting event involving the object 19. Searching the storage device 18 for the GPS location or range will not identify the video footage taken above the stadium by the blimp or airplane. Therefore, the GPS location may be expanded a predetermined amount.

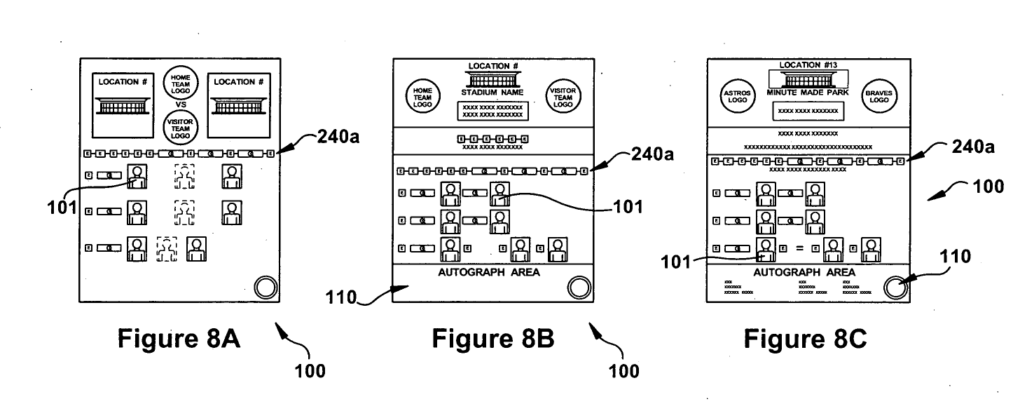

The event time line 240, the information required to create the event time line 24 and/or the other information on the storage device 18 may be accessible via the world-wide web. It is therefore contemplated that virtually any person to access the storage device 18 in order to investigate the origin or events connected with the object 19. In such instances, it may be preferable to require a fee for accessing, recording and transferring the information and data of the system 10. The database software may allow for the generation of a certificate of authenticity to provide the person accessing the system 10 a document providing details about the origin, events and authenticity of the object 19. FIGS. 8A, 8B and 8C illustrate examples of the certificate 100. As shown, the certificate 100 may identify each player 101 that has contacted and/or was involved in an event of the object 19. The certificate 100 may also identify information about the events the object 19 was involved in. FIG. 8C. illustrates an embodiment having an autograph area 110. Each player identified as contacting the object 19 may have a signature block prepared within the autograph area 110. Alternatively, the user may customize the software to limit the autograph area 110 to specific players and/or to players associated with certain events, such as, record-breaking events.

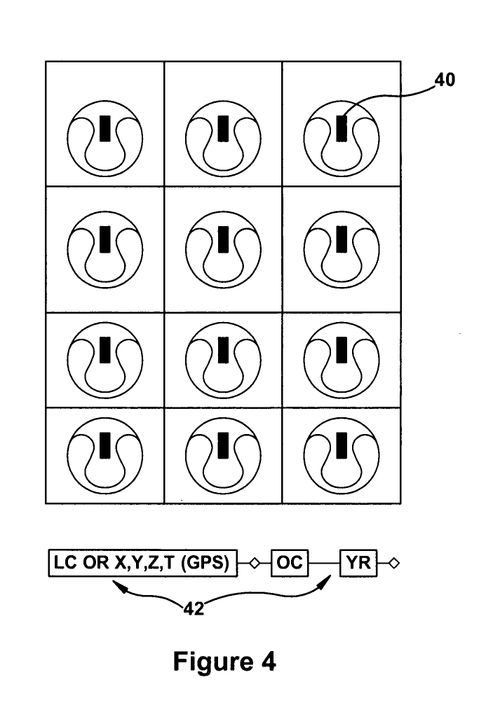

FIG. 3 illustrates the fact that the system 10 can be incorporated on virtually any scale. That is, a single venue or ballpark could incorporate and use the system 10, or relying upon appropriate network technology, it could be possible for the system to be implemented across an entire league. The later example is depicted as system 400 in FIG. 3. In system 400, remote systems 26, each associated with separate competitions or locations, are linked to a centralized server 28. As before, any number of remote work stations 20 can access the server 28 to produce reports 22, such as the certificates 100, in line with considerations discussed above. Notably, remote systems 26 may, but do not necessarily need to, incorporate some or all of the elements shown in FIG. 1. In the event any particular element from FIG. 1 is omitted from one or more of the remote systems 26, it should be understood that the omitted element or an equivalent thereof may be provided across the entire system 400. For example, a single data storage device in system 400 may replace the storage devices 18 in the remote system 26. Although it will be appreciated by those skilled in the art, other similar substitutions or replacements may be possible without departing from the principles of this invention.

This embodiment can be incorporated into a vast amount of situations whether it be recording objects on a playing field or new way of creating a “nervous system” for recording photographs and video information for archiving events by using coordinating bar codes and identification numbers that reflect the x,y,z,t of the object and events. This embodiment can even be integrated into security systems to make them more cohesive and comprehensive.

In yet another embodiment, barcodes can be placed on trading cards that will download footage of the event that is photographed on the card the information may be accessed by a website on the network 13. For example, a trading card of Barry Bonds hitting a record breaking home run will provide access to the website where the footage is saved, including the video footage of the pitch, hit and the player rounding the bases.

In the stadium in which fans possess cameras with GPS/time recording capabilities, trading cards with barcodes may be capable of searching not only for MLB footage of the event but also any uploaded historical accounts/photographs form these fan cameras that have corresponding time and location. Additionally, uploading old footage of games and giving these events relative barcode and GPS/time information may allow this information to be placed on trading cards. Even uploaded movie footage can be used with trading cards that show the footage of the event of the photograph on the trading card. To accomplish such, trading cards with barcodes may have interviews stored on the storage device 18. In another embodiment, the barcodes may be used to distribute prizes such as game tickets. Video footage may correspond to the winning barcode where the video footage includes a player revealing the prize.

Searching by typing in the identifier 40 of the game, such as, the game identification code may identify and/or locate game used balls, jerseys, bats, and other memorabilia. In addition, the search may locate, video footage and/or photographs of the game, for example, and may sort the video footage and/or photographs by object code, player code, team code and/or the like.

In yet another embodiment, the system 10 may be used for security purposes. In this embodiment, if a criminal act were to take place in or around the devices of the system 10, the time and/or location information of the crime may be used to search and identify video footage, photographs, audio recordings and/or the like to help gain information related to the crime. For instance, if a fight begins at a sporting event and a perpetrator flees, but is photographed by an innocent by-standard. The system 10 will allow the photograph to be identified and authenticated by GPS coordinates, time information, object codes of the camera and/or the like.

An illustrative example of a result of the system 10 is a baseball with an unique identification number that references the exact time the ball was on the playing field. The ball is linked to a visual record taken by a video camera that corresponds to the digital information as to what events happened to the ball and what players took part in the history of that ball. The life of the ball is recorded and searchable as a significant part of history. The origin and events of the ball are identifiable and may be authenticated.

The invention has been described above and, obviously, modifications and alternations will occur to others upon a reading and understanding of this specification. The claims as follows are intended to include all modifications and alterations insofar as they come within the scope of the claims or the equivalent thereof.

Having thus described the invention, I claim:

1. A tracking system comprising:
an object capable of being used at a sporting event;
a unique identifier associated with the object;
a scanning device capable of identifying the object by the unique identifier; and
a database storing the unique identifier and information associated with the object, wherein the information is accessible by identifying the unique identifier therein.

2. The tracking system of claim 1 wherein the unique identifier is a barcode.

3. The tracking system of claim 1 wherein the information relates to events occurring at the sporting event involving the object.

4. The tracking system of claim 1 wherein the information includes time and location of the object during the sporting event.

5. The tracking system of claim 4 wherein the information includes video footage of the object.

6. The tracking system of claim 5 further comprising:
a recording device capable of recording the video footage of the object and the time and location of the object.

7. The tracking system of claim 1 wherein information on the database is accessible by identifying a time and a location of the sporting event.

8. The tracking system of claim 1 further comprising:
an event tracker capable of recording plays at the sporting event involving the object.

9. The tracking system of claim 1 wherein the object is a baseball.

10. The tracking system of claim 1 further comprising:
a network in communication with the database, the network providing a plurality of users access to the object identifier and the information on the database.

11. A tracking system comprising:
a plurality of objects each having a unique identifier, the objects capable of being used at a sporting event;
means for identifying each of the objects by the unique identifier associated with each of the objects,
means for storing the unique identifier and information associated with each of the objects; and
means for accessing the information.

12. The tracking system of claim 11 wherein the unique identifier is a radio frequency identification device.

13. The tracking system of claim 11 wherein the information comprises a visible image of at least a portion of the sporting event involving each of the objects.

14. The tracking system of claim 11 further comprising:
means for tracking plays at the sporting event involving the object.

15. The tracking system of claim 11 wherein the information comprises time and location information of at least one of the objects.

16. The tracking system of claim 11 further comprising:
means for recording visual information of at least one of the objects and associating the visual information with the unique identifier of at least one of the objects.

17. The tracking system of claim 11 further comprising:
means for locating the information of the object based on location or time of the sporting event.

18. The tracking system of claim 11 further comprising:
means for identifying players possessing one of the objects and circumstances related to the possession of one of the objects by the player.

19. The tracking system of claim 11 further comprising:
means creating a report illustrating plays involving the object and players.

20. A method for tracking an object capable of being used at a sporting event, the method comprising the steps of:
providing a unique identifier for an object;
recording information relating to the object on a database, the information comprising visual information, statistical information, player information or event information;
storing the information and the identifier on the database; and
searching the database to locate the information based on the identifier or data related to the information.
